(19) United States
(12) Patent Application Publication
(10) Pub. No.: US 2015/0334234 A1
(43) Pub. Date: Nov. 19, 2015

(54) STRUCTURED STORAGE MANAGEMENT FOR INTERACTIONS RECORDING

(71) Applicant: NICE-SYSTEMS LTD, Ra'anana (IL)

(72) Inventors: Yotam ATAD, Kadima-Zoran (IL); Matan KERET, Oulu (FI); Efim KOLODIZNER, Ashdod (IL); TaI ZUR, Rishon-Lezion (IL); Shlomi LEVI, Kfar Saba (IL)

(73) Assignee: NICE-SYSTEMS LTD, Ra'anana (IL)

(21) Appl. No.: 14/277,833

(22) Filed: May 15, 2014

(51) Int. Cl. H04M 3/51; H04M 3/22

(52) U.S. Cl. CPC H04M 3/5183; H04M 3/2218

(57) ABSTRACT

A computerized method for managing storage of interactions of calls received by a communication apparatus, comprising creating on a storage device by a computerized apparatus in advance of the calls a hierarchy of partitions comprising an at least one date partition representing a date and a plurality of time partitions representing times of the date descendent from the at least one date partition, thereby consecutively representing time intervals, and according to an agreed upon convention of the hierarchy of partitions and representations thereof created in advance of the calls, autonomously recording interactions of the calls in a time partition representative of beginning of a time interval in which the calls were received, and an apparatus for performing the same.

### BACKGROUND

The present disclosure generally relates to data and storage management, and more specifically to a structured storage management for recording.

Some recording systems manage storage area where data of interactions, such as telephonic calls, is saved on an unformatted partition as raw data which, generally, necessitate association of metadata about the interactions and tools for accessing and utilizing the recordings.

In an organization, such as a call center, tens or hundreds of agents may attend to hundreds or thousands of concurrent calls, so that controlling storage and retrieval of recordings of such an amount of data may detrimentally affect computational load and response time.

### SUMMARY

One exemplary embodiment of the disclosed subject matter is a computerized method for managing storage of interactions of calls received by a communication apparatus, comprising creating on a storage device by a computerized apparatus in advance of the calls a hierarchy of partitions comprising an at least one date partition representing a date and a plurality of time partitions representing times of the date descendent from the at least one date partition, thereby consecutively representing time intervals, and according to an agreed upon convention of the hierarchy of partitions and representations thereof created in advance of the calls, autonomously recording interactions of the calls in a time partition representative of beginning of a time interval in which the calls were received.

Another exemplary embodiment of the disclosed subject matter an apparatus for managing storage of interactions of calls received by a communication apparatus, comprising a computerized apparatus configured for creating in advance of the calls a hierarchy of partitions comprising an at least one date partition representing a date and a plurality of time partitions representing times of the date descendent from the at least one date partition, thereby consecutively representing time intervals, and a computerized communication interface system interactive with the communication apparatus and communicative with the computerized apparatus configured for recording, in accordance with an agreement as to the hierarchy of partitions and representations thereof, interactions of the calls in a time partition representative of beginning of a time interval in which the calls were received.

### BRIEF DESCRIPTION OF THE DRAWINGS

Some non-limiting exemplary embodiments or features of the disclosed subject matter are illustrated in the following drawings.

Identical or duplicate or equivalent or similar structures, elements, or parts that appear in one or more drawings are generally labeled with the same reference numeral, and may not be repeatedly labeled and/or described.

Dimensions of components and features shown in the figures are chosen for convenience or clarity of presentation and are not necessarily shown to scale or true perspective. For convenience or clarity, some elements or structures are not shown or shown only partially and/or with different perspective or from different point of views.

References to previously presented elements are implied without necessarily further citing the drawing or description in which they appear.

FIG. 1 schematically illustrates an interface unit for recording interactions such as known in the art or a variation thereof;

FIG. 2A schematically illustrates an organization of folders for recording interactions in advance of the interactions, according to exemplary embodiments of the disclosed subject matter;

FIG. 2B schematically illustrates an organization of folders extended with folders and files of interactions recordings, according to exemplary embodiments of the disclosed subject matter;

FIG. 3 schematically illustrates a coordinated operation of an interface unit and a folder management unit, according to exemplary embodiments of the disclosed subject matter;

FIG. 4A outlines operations of folder management unit, according to exemplary embodiments of the disclosed subject matter;

FIG. 4B outlines operations of folder management unit, according to exemplary embodiments of the disclosed subject matter;

FIG. 5 outlines operations for providing a location for recordings, according to exemplary embodiments of the disclosed subject matter; and

FIG. 6 outlines operations for management of interaction recording, according to exemplary embodiments of the disclosed subject matter.

### DETAILED DESCRIPTION

In the context of the present disclosure, without limiting, an interaction implies an audio interaction such as a telephone call between parties, without precluding other media such as text, video and/or imaging. For example, an interaction ensuing from a telephonic call, possibly with intervening transmission of computer screenshots and/or text, or, for example, a video conference possibly with intervening text, or, for example, a computerized chat possibly with intervening images. An interaction generally occurs between at least two parties with possible intervening transfers.

An interaction may be split to a plurality of interactions or sub-interactions, for example, audio data respective to any participating party, or, for example, audio data and imaging data. Unless specifically stated, for brevity, referring to an interaction implies also the sub-interactions.

For brevity and fluency, as an interaction follows a call, according to the context referring to a call may refer to an ensuing interaction, thus having the same start time or sufficiently insignificant start time difference therebetween.

In the context of the present disclosure, without limiting, the term CTI implies any device and/or apparatus for computer telephony and/or communications integration as known in the art or a custom apparatus for that effect, wherein telephony and/or communications imply any communication technique or technology such as PSTN and/or VoIP and/or cellular communication and/or wireless communication such as WiFi.

In the context of the present disclosure, without limiting, the term ‘interface unit’ implies a computerized apparatus that interfaces with a CTI to obtain information pertaining to a call arriving at the CTI such as the time of the call, and contents of the call such as audio stream and/or any data type that constitutes and/or comprises an interaction.

In the context of the present disclosure, without limiting, a folder implies any partition of a storage space on and/or in one or more storage devices, organized to support interior partitions therein as nested partitions, such as a tree-like organization, as well as files. For example, a folder of a file-system as known in the art.

The terms cited above denote also inflections and conjugates thereof.

One technical problem dealt by the disclosed subject matter is effectively managing storage of recordings of numerous concurrent interactions that may amount to hundreds or thousands of concurrent interactions, sufficiently fast without missing valuable information and/or avoiding costly high-throughput equipment.

One technical solution according to the disclosed subject matter is forming in advance of the recordings an array of folders arranged according to dates that represent the dates, and within a folder of a date forming an array of folders based on start times of the dates. The folders based on times represent consecutive times of a day, thus forming representative time intervals.

Generally according to an agreement as to the form and naming of the array of folders, when a call arrives then a folder is autonomously created under the folder of the current date in the representative time interval according to the start time of the call. For example, in case the time intervals represent hourly intervals, then if a call arrived on 23:15 the folder is created in the representative interval between 23:00 up to 24:00.

The folder created in a representative time interval is named by a composite name formed with fields including the call's start time and other information that uniquely identify the call, and the call's contents or interaction there of is autonomously stored in a provided space as a file or files under the folder in the representative time interval.

More specifically, an interface unit interacting with a CTI receives the call, and based on the time of the call the interface unit forms the composite name and creates a folder with the composite name in the appropriate folder of the date and representative time. Subsequently, the interface unit creates a file and/or files in which the interaction and/or sub-interactions, respectively, are stored or recorded under the folder with the composite name in a representative time interval respective to the call's start time.

Thus, according to the folder names representing date and time intervals, determining the path or location for recording is straightforward and fast, avoiding any elaborate computations. Likewise, retrieving a storage location of a recording may be directly obtained according to the date and time of the interaction.

A potential technical effect of the disclosed subject matter is a simple fast mechanism for management of recording of numerous concurrent communication interactions without undue costly equipment.

A consequent technical effect of the disclosed subject matter is independence of the operation of constructing the folders organization in advance of the recordings and the subsequent autonomous operation of recoding of the interactions in the folders organization, thus allowing simple and/or flexible management of the processes.

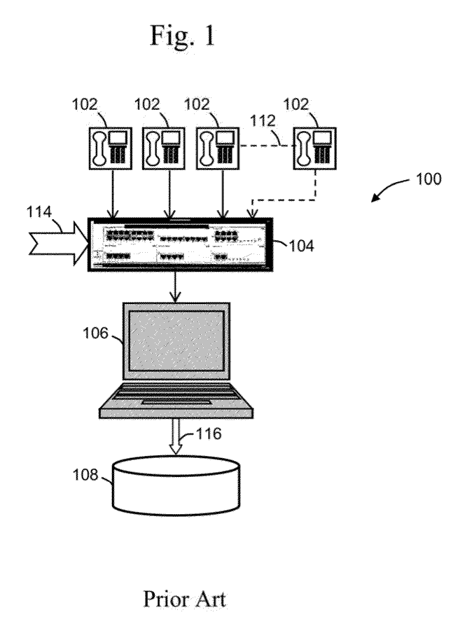

FIG. 1 schematically illustrates an interface unit 100 for recording interactions such as known in the art or a variation thereof.

A multi-trunk and/or multi-line communications link such as of telephonic communications or VoIP or similar ones, represented by an arrow 114, is connected to a CTI 104 representing any computer integration apparatus.

As represented by a dashed line 112, any number of telephones as a telephone 102 is connected to CTI 104, telephone 102 representing any telephonic device such as microphone/earphone combination and/or a computerized sound apparatus.

Calls and/or interaction arriving at CTI 104 are handled and/or processed by a computerized apparatus represented by a computer 106, which interacts with a storage device 108 for recording the interactions in partitions and/or files in or on storage device 108, as represented by an arrow 116.

In some embodiments, storage device 108 represents a plurality of storage devices, optionally considered collectively as one logical device.

Computer 106 is configured for acquiring the date and time of received calls, such as from CTI 104 and/or real-time clock, and for constructing a data structure with characteristics of the calls.

Based on the date and time of the received calls and/or elements of the data structure, computer 106 creates folders with unique names with respect to received calls for recording the calls or interactions thereof. The folders with the unique names are created within descendent partitions of a pre-set organization of partitions (described later on), in or on storage device 108. The descendent partitions of a pre-set organization of partitions where to create the folders with the unique names for recording the calls or interaction thereof are determined according to a pre-coordination or a convention as for the pre-set organization of partitions.

An interface unit such as interface unit 100 is also referred to as a communication interface system.

Without limiting, according to exemplary embodiments of the present disclosure the subject matter thereof relates to the organization and naming of partitions in or on storage device 108 for instantly and directly deriving location for storing interactions of received calls.

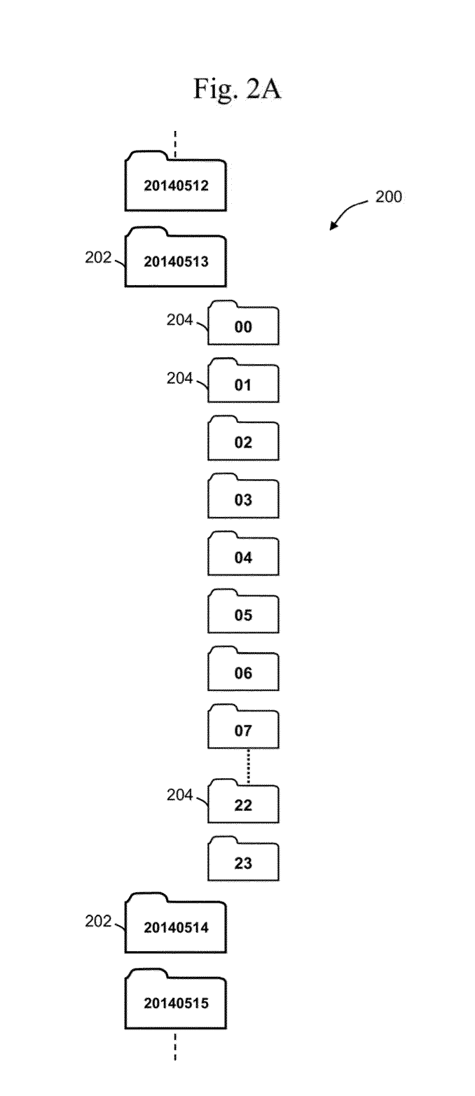

FIG. 2A schematically illustrates a folders organization 200 of folders for recording interactions as formed on storage device 108 in advance of the interactions, according to exemplary embodiments of the disclosed subject matter.

Folders organization 200 may originate or stem from any location of storage device 108, for example, from a root directory of a file system operative on storage device 108, or from any folder thereof.

Folders organization 200 comprises folders representing dates, denoted as date folders, as illustrated by any of a date folder 202. The names of the date folders are based on a date. For example, and as exemplarily illustrated in FIG. 2A, a date is constructed as |year|month|day|, so that the string ‘20140513’ stands for May 13, 2014. Optionally, any construct that represents and/or reflects the date may be used.

Under each date folder a consecutive series of folders representing times, denoted as time folders, is formed, as illustrated by any of a time folder 204. For example, and as used in FIG. 2A, a name of a time folder is a string indicating the hour, so that ‘00’ stands for midnight and ‘23’ stands for 11 PM. Optionally, any construct that represents and/or reflects the time of day may be used.

For every day, and optionally for the next day or the next few days, folders organization 200 comprising at least the day's date folder and descendent time folders is constructed ahead of time of at least potentially incoming interactions, as exemplified later on.

Thus, the period from a time represented by a time folder and up to the time represented by a subsequent time folder represents a time interval, where interactions that started in a time within the time interval are recorded under or within a time folder that represents the beginning of the respective time interval.

In some embodiments, as a call arrives at CTI 104 at a certain time of a date, computer 106 determines fields for naming a folder with a unique name with respect to the call that identify the call and/or distinguishes the call with respect to other calls. The folder with the unique name, denoted also as a unique folder, is created in or under a time folder that represents the beginning of the respective time interval in which the call has arrived and/or the interaction thereof has started.

Subsequently, computer 106 begins to record the interactions, and possibly sub-interactions, in files or files within or under the unique folder in a representative time interval to which the start time of the calls and/or interaction corresponds.

For example, if a call started at 7:16 AM then the interaction of the call and/or sub-interactions thereof are recoded and saved under time folder named ‘07’ in a unique folder of the call in one or more files respective to the interaction and/or sub-interactions.

It is noted that computer 106 creates the unique folder on storage device 108 according to a pre-coordination or convention regarding the structure and naming of folder in folders organization 200.

Thus, the beforehand construction of folders organization 200 and recording of calls by computer 106 are independent from each other and coordinated therebetween only by the implied convention of the structure and naming of folder in folders organization 200.

In some embodiments, the unique name of the unique folder is constructed to plainly include or represent the date and time of a call. Optionally, the unique name is constructed according to a formula and/or an algorithm based on the date and time of the call. Unique names of folders are exemplified later on.

FIG. 2B schematically illustrates folders organization 200 extended with extended folders and files 220 of interactions recordings, according to exemplary embodiments of the disclosed subject matter.

By way of example, assuming a case where a call arrives, or an interaction starts, on May 13, 2014 at 07:16:01. Consequently, as the start time is after 7 AM yet before 8 AM, a unique folder is created under folder ‘07’, indicated as a unique folder 206, with a name formed as |year|month|day|hour|minute| second representing the date and start time of an interaction. Thus, according to the example, the unique folder is named as ‘20140513071601’. Under the unique folder computer 106 creates an interaction recording file, indicated as an interaction file 208, which is named, for example, named as ‘Audio01’.

Similarly, by way of example, for a call arriving at 07:17:51 a unique folder is created with a name ‘20140513071751’, and in case the interaction involves additional two transfers three interaction recording files are created under the unique folder as, for example, ‘Audio 01’ . . . ‘Audio03’.

In some embodiments, the time resolution may be modified, for example, comprising also tenth of seconds.

In some embodiments, the name of folders and/or unique folders may be represented by ASCII numerals or by any format such as, for example, by hexadecimal coding.

In some embodiments, no date and/or time are explicitly represented in the names of the unique folders as the date and/or time may be construed from the respective parent folders.

In some embodiments, a unique folder name may comprise additional fields derived from CTI 104 and/or interface unit 100, such as for caller's identification or caller's code or identification of the CTI. Likewise, in some embodiments, the names of the interaction recording files may be formed in any format as long as the names are different from each other. Likewise, in some embodiments, a unique folder name and/or an interaction recording file may comprise additional fields for metadata. For example, an interaction recording file may comprise an indication, such as by a code, of an agent handling the interaction.

In some embodiments, an interaction comprises other media than audio data. For example, a video interaction of transmission and/or exchange of images such as screen shots. Thus, for example, the interaction recording files may be named accordingly such as ‘Video02’ or ‘Imageo1’. In some embodiments, the interaction recording files may be named according to the party and/or parties of the interaction. For example, ‘Customer 924’, or ‘Agent 31’ and so forth.

It is noted that interaction recording files such as interaction file 208 may be stored on other location of storage device 108 and/or another storage device, provided that under the respective unique folder and/or in data accessible via the unique folder are furnished locations such as paths of the recording files.

It is emphasized that an interaction, such as from the start of a call until termination of a call, may be conducted for a time that exceeds the time that correspond to the starting time of an interaction. For example, an interaction that started at 7.16 AM may end at 9:10 AM.

According to embodiments of the disclosed subject matter, however, the key factor for managing the recordings of interactions in time folders of folders organization 200 is the starting time of calls and/or of interactions, irrespective at which time and/or date the interaction actually ends.

Thus, by the names of date folders and time folders computer 106 determines where to record the incoming interactions. Likewise, retrieval of interactions recordings can be straightforwardly unequivocally located.

It is noted that the folders and files are constructed in any suitable framework, such as a file-system as known in the art, collectively referred to as a file-system. For example, NTFS (Microsoft Inc.) folders and file or UNIX (Unix® The Open Group) directories and files.

The relation between the folders or folders organization 200 and extended folders thereof in FIGS. 2A and 2B is evident from the indentation therebetween, though, for clarity, connections between the folders are not shown. Dashed lines indicate extensions of the date folders and a dotted line indicates progression of the time folders.

In some embodiments, folders organization 200, the time intervals represented by the time folders are hourly intervals. Optionally or alternatively, the time intervals are uniform intervals of less than a hour. Further optionally or alternatively, the time intervals are uniform intervals or more than a hour. In some embodiments, the time intervals are non-uniform, for example, the intervals are determined according to the calls rate of frequency, as, for example, on weekends or holidays there are fewer calls than in regular work days.

In some embodiments, the time resolution represented by a time folder is by seconds. Optionally or alternatively, the time resolution is less than a second, for example, by milliseconds. In some embodiments, the time resolution is determined by the rate of expected call, based, for example, on rate of workdays relative to holidays.

In some embodiments, a plurality of folders organization 200 is formed on storage device 108, for example, as one for a year. Thus, in case folders organization 200 descends from a folder representative of a year, the name of a date folder, as a year is concerned, may be derived from the name of the parent folder.

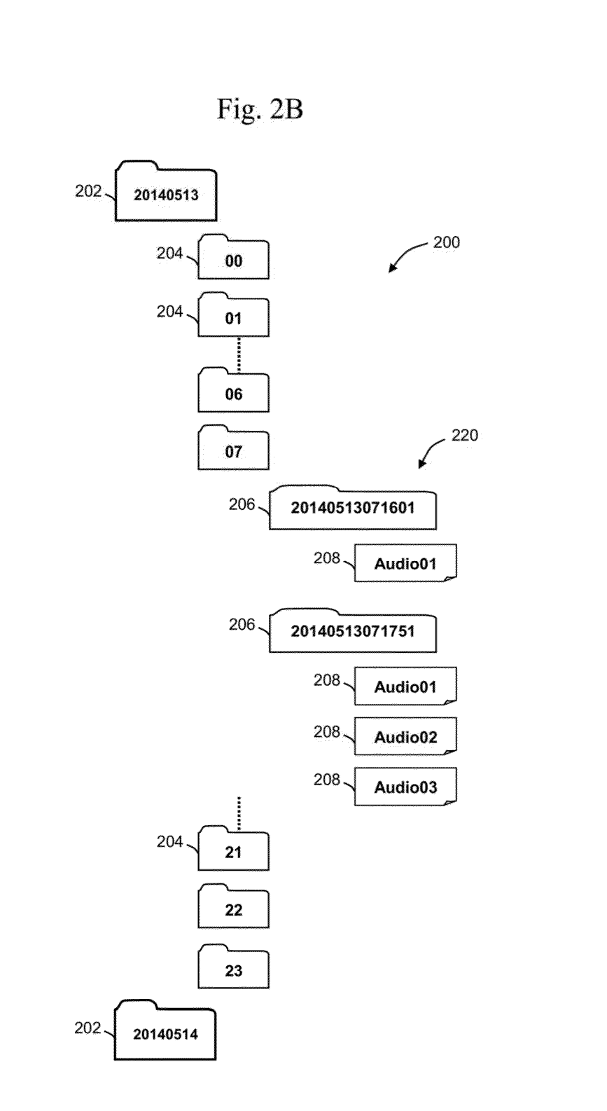

FIG. 3 schematically illustrates a coordinated operation of an interface unit and a folder management unit, according to exemplary embodiments of the disclosed subject matter.

An organization of folders for recording, such as folders organization 200, is created by a computerized apparatus accessible to storage device 108 and operating according to one or more programs referred to as a folder management unit and denoted as a folder management unit 302. As illustrated by an arrow 312, folders organization 200 is created in and/or according to a file-system, referred to also a file-system 308, which represents any suitable framework for folders and files.

Folder management unit 302 creates folders organization 200 or part thereof comprising at least date and time folders respective to possible interactions yet to occur ahead of the interactions. For example, folder management unit 302 operates periodically such as every day or every hour or according to any suitable regime, for example, every midnight or a minute before midnight.

As illustrated by an arrow 314, as folders organization 200 or part thereof has been created in advance, in some embodiments, interface unit such as interface unit 100 creates unique folders and interaction files within and/or under folders organization 200, such as extended folders and files 220 in, responsive to incoming interactions and in accordance to the date and start times of the interactions.

It is noted that the operations of interface unit 100 and folder management unit 302 are in fact independent of each other so that each operates autonomously, provided merely that folders organization 200 and naming thereof are beforehand agreed upon. Thus, the cooperation of interface unit 100 and folder management unit 302 is based only on a convention rather than relying on any further software and/or hardware facilities or provisions.

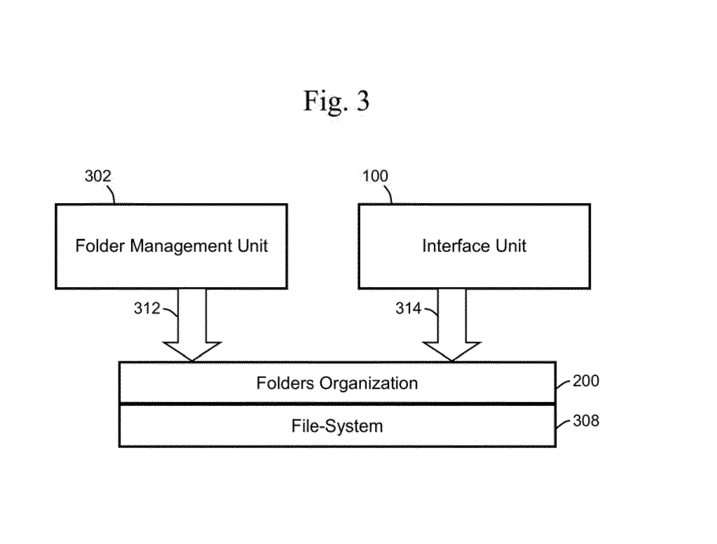

FIG. 4A outlines a procedure 400 of operations of folder management unit, according to exemplary embodiments of the disclosed subject matter.

As procedure 400 is started and/or called, in operation 402 it is checked whether the present day's date folder and respective time folders already exist.

In case of a negative outcome, in operation 404 the present day's date folder and respective time folders are created, and in operation 406 a mechanism of delay, such as a timer as indicated by the clock symbol, is activated which restarts operation 402 as the delay has lapsed, as indicated by an arrow 408. In some embodiments, the delay is somewhat less than a day so that upon restart of procedure 400 the next day's folders would be created in advance.

In case of a positive outcome of operation 402, operation 406 is activated, possibly with a shorter delay relative to the delay according to the negative outcome of operation 402, possibly longer than a day.

FIG. 4B outlines a procedure 420 as a variation of procedure 400, according to exemplary embodiments of the disclosed subject matter.

As procedure 420 is started and/or called, in operation 422 it is checked whether date folders and respective time folders of a range of in advance dates already exist.

In case of a negative outcome, in operation 424 one or more date folders and respective time folders are incrementally created to complete in advance the date folders and respective time folders of the range of dates, and in operation 426 a mechanism of delay, such as a timer as indicated by the clock symbol, is activated which restarts operation 422 responsive to lapse of the delay, as indicated by an arrow 428. In some embodiments, according to the rage of dates, the delay is somewhat less than a day or of one or more dates so that upon restart of procedure 420 the subsequent date folders and respective time folders would be created in advance.

In case of a positive outcome of operation 422, operation 426 is activated, possibly with a shorter delay relative to the delay according to the negative outcome of operation 422.

In some embodiments, the range of in advance dates is predefined and/or determined. For example, the range is predefined as three days to ensure that the folders organization is ready for recording, or, for example, the range is determined according to the load of calls.

Procedure 400 and procedure 420 may, in some embodiments, be varied. For example, operation 406 and/or operation 426 may precede operation 402 and/or operation 422, respectively.

In some embodiments, based on administrative information of an underlying infrastructure such as an operating system and/or extracted from the CTI 104, interface unit 100, such as by computer 106, determines and/or constructs a structure respective of a call or an interaction, referred to as a compound identification or a compound-ID.

An exemplary structure of a compound-ID is lineated in Table-1 below.

TABLE 1

| | Number of | |
|---|---|---|
| Name | bytes | Description |
| Date and Time | 4 | Date and Time of creation |
| Site ID | 1 | The site of the compound (mostly 1) |
| Resource ID | 1 | A general ID of the unit that creates the |
| | | compound |
| Internal | 2 | A running number that it being reset every 1 |
| Counter | | second |

Where:

The interaction date and start time are encoded and/or formatted in 4 bytes.

The site ID to distinguish, for example, between recordings from a plurality of sites.

The resource ID to distinguish between recordings from a plurality of interface units.

The internal counter to distinguish between calls and/or interactions that start on the same second.

Subsequently to determining and/or constructing the compound-ID a unique folder named according to the compound-ID is created such as by computer 106 in the time folder respective to the start time of the interaction and under the respective date of the interaction or

It is noted that the structure of the compound-ID exemplified above is not necessarily mandatory according the disclosed subject matter, and variations thereof may used as long as the name of the unique folder plainly and directly characterizes the interaction and/or sub-interactions and is distinctive with respect to other interactions. For example, names unique folders described above.

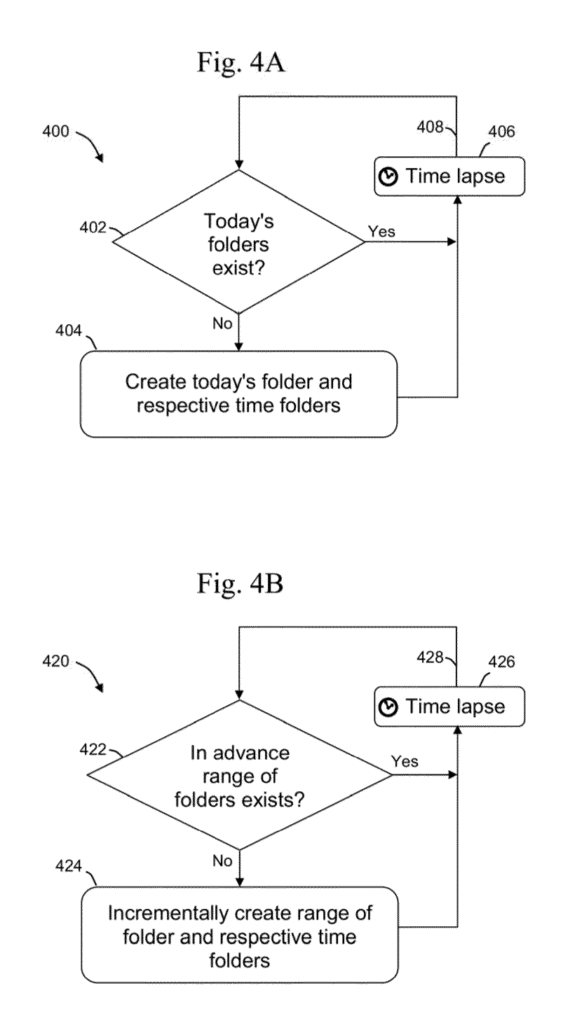

FIG. 5 outlines operations 500 for providing a location for recordings, according to exemplary embodiments of the disclosed subject matter.

In operation 502 a data structure of characteristics of a received call including date and start time of the call is obtained, generally by an interface unit such as interface unit 100. In some embodiments, the data structure is as compound-ID exemplified in Table-1 above or a variation thereof.

Generally, in some embodiments, the data structured is provided to a folder management unit such as folder management unit 302 described above.

Generally in and/or by the folder management unit, in operation 504 the date and time are extracted from the data structure, and in operation 506 a folder name as a path based on a hierarchy of the date and time as a time folder under a date folder, such as described above, is formed.

In operation 508 the path is provided back to the interface unit for recording interaction in the path.

Operations 500 are provided as an example and two or more operations may be combined, for example, operation 504 and operation 506 may be combined into one operation.

In some embodiments, optionally, operations 500, except of operation 508, are carried out in the interface unit.

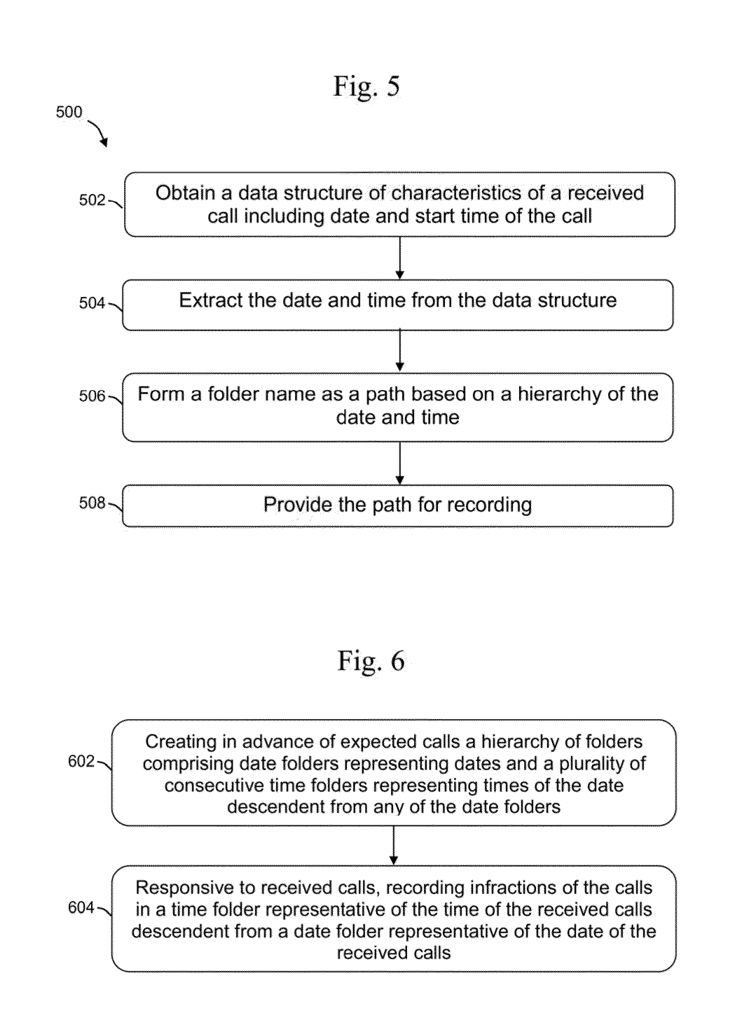

FIG. 6 outlines operations for management of interaction recording, according to exemplary embodiments of the disclosed subject matter.

In operation 602 a hierarchy of folders comprising date folders representing dates and a plurality of consecutive time folders representing times of the date descendent from any of the date folders is created in advance of expected calls.

In some embodiments, one date folder with a descendent plurality of time folders are created in advance of the calls or, optionally, a plurality of date folders with a descendent plurality of time folders are created in advance of the calls.

In some embodiments, the time intervals represented by adjacent time folders is uniform, such intervals of round hours or intervals larger than a hour or smaller than a hour. Optionally or alternatively, the time intervals are non-uniform, for example, according to the rate of calls, as in some cases lower rate of calls is expected night hours relative to day hours.

In some embodiments, the hierarchy of folders is created by a computerized apparatus such as folder management unit 302.

In operation 604, responsively to received calls interactions of the calls are recorded in a time folder representative of the time of the received calls descendent from a date folder representative of the date of the received calls.

In some embodiments, the recording is carried out by a communication interface system interactive with the communication apparatus, as for example, interface unit 100 that interacts with CTI 104. Optionally, the computerized apparatus in charge of creating the hierarchy of folders such as folder management unit 302 and the communication interface system such as interface unit 100 communicate therebetween to resolve, based on date and time of incoming calls, the time folder in which an interaction is recorded.

It is noted that, at least in some embodiments, operation 604 is carried out autonomously with respect of operation 602 provided that the folders representative of the date and time of the received calls have been created according to an agreed convention.

It is reiterated and emphasized that an advantage, at least a potential one, according to the present disclosure is a simple hierarchical arrangement of folders and naming thereof according to dates and times, so that a locations of storing and retrieval of recordings of calls can be found straightforwardly and practically instantaneously, thus avoiding time consuming elaborate computations and possible use of auxiliary data which may be detrimental in a system that has to handle numerous concurrent calls. Further, all the interactions and sub-interactions of a call are stored in a single unique folder in the folders arrangement which distinctively and directly identifies the call so that no superfluous operations are necessary for locating interactions of the call.

Additionally, the folders are ordinarily arranged according to the underlying infrastructure such as an operating system, thereby avoiding custom-made or unusual structures for storing interactions of calls which may require undue computations and execution times.

Furthermore, at least in embodiments where the communication interface system creates the folder and files for recording of interaction, the process of preparing the folders hierarchies and the process of recording are independent of each other and/or are autonomous, having in common only the convention or agreement as to the folders organization and naming.

Thus, management of the processes is convenient and/or flexible. For example, the communication interface system may be replaced or upgraded, and in different organization different communication interface systems may be used, having only to keep the keeping only the convention of the folders organization.

There is thus provided according to the present disclosure a computerized method for managing storage of interactions of calls received by a communication apparatus, comprising creating on a storage device by a computerized apparatus in advance of the calls a hierarchy of partitions comprising an at least one date partition representing a date and a plurality of time partitions representing times of the date descendent from the at least one date partition, thereby consecutively representing time intervals, and according to an agreed upon convention of the hierarchy of partitions and representations thereof created in advance of the calls, autonomously recording interactions of the calls in a time partition representative of beginning of a time interval in which the calls were received.

In some embodiments, the recording is carried out by a computerized communication interface system interactive with the communication apparatus and communicative with the computerized apparatus.

In some embodiments, the computerized apparatus provides the location where to record the interactions based on date and start time of the calls provided to the computerized apparatus by the computerized communication interface system.

In some embodiments, the at least one date partition representing a date comprises a plurality of partitions correspondingly representing a plurality dates with descendent time partitions consecutively representing times of the plurality of dates as time intervals.

In some embodiments, the times intervals are hourly intervals.

In some embodiments, the times intervals correspond to less than a hour.

In some embodiments, the times intervals correspond to more than a hour.

In some embodiments, the times intervals are non-uniform.

There is thus further provided according to the present disclosure an apparatus for managing storage of interactions of calls received by a communication apparatus, comprising a computerized apparatus configured for creating in advance of the calls a hierarchy of partitions comprising an at least one date partition representing a date and a plurality of time partitions representing times of the date descendent from the at least one date partition, thereby consecutively representing time intervals, and a computerized communication interface system interactive with the communication apparatus and communicative with the computerized apparatus configured for recording, in accordance with an agreement as to the hierarchy of partitions and representations thereof, interactions of the calls in a time partition representative of beginning of a time interval in which the calls were received.

In some embodiments, the computerized apparatus is configured to provide the location where to record the interactions based on date and start time of the calls provided to the computerized apparatus by the computerize communication interface system.

In the context of some embodiments of the present disclosure, by way of example and without limiting, terms such as ‘operating’ or ‘executing’ imply also capabilities, such as ‘operable’ or ‘executable’, respectively.

Conjugated terms such as, by way of example, ‘a thing property’ implies a property of the thing, unless otherwise clearly evident from the context thereof.

The terms ‘processor’ or ‘computer’, or system thereof, are used herein as ordinary context of the art, such as a general purpose processor or a micro-processor, RISC processor, or DSP, possibly comprising additional elements such as memory or communication ports. Optionally or additionally, the terms ‘processor’ or ‘computer’ or derivatives thereof denote an apparatus that is capable of carrying out a provided or an incorporated program and/or is capable of controlling and/or accessing data storage apparatus and/or other apparatus such as input and output ports. The terms ‘processor’ or ‘computer’ denote also a plurality of processors or computers connected, and/or linked and/or otherwise communicating, possibly sharing one or more other resources such as a memory.

The terms ‘software’, ‘program’, ‘software procedure’ or ‘procedure’ or ‘software code’ or ‘code’ or ‘application’ may be used interchangeably according to the context thereof, and denote one or more instructions or directives or circuitry for performing a sequence of operations that generally represent an algorithm and/or other process or method. The program is stored in or on a medium such as RAM, ROM, or disk, or embedded in a circuitry accessible and executable by an apparatus such as a processor or other circuitry.

The processor and program may constitute the same apparatus, at least partially, such as an array of electronic gates, such as FPGA or ASIC, designed to perform a programmed sequence of operations, optionally comprising or linked with a processor or other circuitry.

The term computerized apparatus or a computerized system or a similar term denotes an apparatus comprising one or more processors operable or operating according to one or more programs.

As used herein, without limiting, a module represents a part of a system, such as a part of a program operating or interacting with one or more other parts on the same unit or on a different unit, or an electronic component or assembly for interacting with one or more other components.

As used herein, without limiting, a process represents a collection of operations for achieving a certain objective or an outcome.

As used herein, the term ‘server’ denotes a computerized apparatus providing data and/or operational service or services to one or more other apparatuses.

The term ‘configuring’ and/or ‘adapting’ for an objective, or a variation thereof, implies using at least a software and/or electronic circuit and/or auxiliary apparatus designed and/or implemented and/or operable or operative to achieve the objective.

A device storing and/or comprising a program and/or data constitutes an article of manufacture. Unless otherwise specified, the program and/or data are stored in or on a non-transitory medium.

In case electrical or electronic equipment is disclosed it is assumed that an appropriate power supply is used for the operation thereof.

The flowchart and block diagrams illustrate architecture, functionality or an operation of possible implementations of systems, methods and computer program products according to various embodiments of the present disclosed subject matter. In this regard, each block in the flowchart or block diagrams may represent a module, segment, or portion of program code, which comprises one or more executable instructions for implementing the specified logical function(s). It should also be noted that, in some alternative implementations, illustrated or described operations may occur in a different order or in combination or as concurrent operations instead of sequential operations to achieve the same or equivalent effect.

As used herein, the singular forms “a”, “an” and “the” are intended to include the plural forms as well, unless the context clearly indicates otherwise. It will be further understood that the terms “comprises” and/or “comprising” and/or “having” when used in this specification, specify the presence of stated features, integers, steps, operations, elements, and/or components, but do not preclude the presence or addition of one or more other features, integers, steps, operations, elements, components, and/or groups thereof.

As used herein, ellipsis ( . . . ) between two entities or values denotes an inclusive range of entities or values, respectively. For example, A . . . Z implies all the letters from A to Z, inclusively.

The terminology used herein should not be understood as limiting, unless otherwise specified, and is for the purpose of describing particular embodiments only and is not intended to be limiting of the disclosed subject matter. While certain embodiments of the disclosed subject matter have been illustrated and described, it will be clear that the disclosure is not limited to the embodiments described herein. Numerous modifications, changes, variations, substitutions and equivalents are not precluded.

1. A computerized method for managing storage of interactions of calls received by a communication apparatus, comprising:
creating on a storage device by a computerized apparatus in advance of the calls a hierarchy of partitions comprising an at least one date partition representing a date and a plurality of time partitions representing times of the date descendent from the at least one date partition, thereby consecutively representing time intervals; and
according to an agreed upon convention of the hierarchy of partitions and representations thereof created in advance of the calls, autonomously recording interactions of the calls in a time partition representative of beginning of a time interval in which the calls were received.

2. The method according to claim 1, wherein the recording is carried out by a computerized communication interface system interactive with the communication apparatus and communicative with the computerized apparatus.

3. The method according to claim 2, wherein the computerized apparatus provides the location where to record the interactions based on date and start time of the calls provided to the computerized apparatus by the computerized communication interface system.

4. The method according to claim 1, wherein the at least one date partition representing a date comprises a plurality of partitions correspondingly representing a plurality dates with descendent time partitions consecutively representing times of the plurality of dates as time intervals.

5. The method according to claim 1, wherein the times intervals are hourly intervals.

6. The method according to claim 1, wherein the times intervals correspond to less than a hour.

7. The method according to claim 1, wherein the times intervals correspond to more than a hour.

8. The method according to claim 1, wherein the times intervals are non-uniform.

9. An apparatus for managing storage of interactions of calls received by a communication apparatus, comprising:
a computerized apparatus configured for creating in advance of the calls a hierarchy of partitions comprising an at least one date partition representing a date and a plurality of time partitions representing times of the date descendent from the at least one date partition, thereby consecutively representing time intervals; and
a computerized communication interface system interactive with the communication apparatus and communicative with the computerized apparatus configured for recording, in accordance with an agreement as to the hierarchy of partitions and representations thereof, interactions of the calls in a time partition representative of beginning of a time interval in which the calls were received.

10. The apparatus according to claim 9, wherein the computerized apparatus is configured to provide the location where to record the interactions based on date and start time of the calls provided to the computerized apparatus by the computerize communication interface system.
